(19) United States
(12) Patent Application Publication
(10) Pub. No.: US 2007/0227605 A1
(43) Pub. Date: Oct. 4, 2007

(54) Resin Composite Hose of Curved Shape and Method for Producing the Same

(76) Inventors: Kazushige Sakazaki, Komaki-shi (JP); Kohei Tsunetomo, Matusaka-shi (JP)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 11/692,212

(22) Filed: Mar. 28, 2007

(30) Foreign Application Priority Data
Mar. 28, 2006 (JP) 2006-089387
Mar. 23, 2007 (JP) 2007-076560

(51) Int. Cl. F16L 9/00; B29C 47/06; B29C 47/20

(52) U.S. Cl. 138/109; 138/137; 138/141; 138/DIG. 11; 264/171.27; 264/209.3

(57) ABSTRACT

A resin composite hose of curved shape includes a resin layer having permeation resistance to a transported fluid and serving as a barrier layer, an inner rubber layer as an inner surface layer on an inner side of the resin layer and an outer rubber layer on an outer side of the resin layer. The resin composite hose has one axial end that is larger in diameter than the other axial end thereof. The resin composite hose has at least one curved portion. The curved portion is formed in a shape of progressively and continuously increasing diameter from a curve beginning end with a small diameter near the other axial end of the resin composite hose to a curve terminal end with a large diameter near the one axial end thereof.

### BACKGROUND OF THE INVENTION

1. Field of the Invention

The present invention relates to a resin composite hose of curved shape including a resin layer that is disposed in the middle of multilayers, has a permeation resistance to a transported fuel and serves as a barrier layer, and a method for producing such a resin composite hose of curved shape.

2. Description of the Related Art

For application of a fluid transporting hose, for example, a fuel hose in a motor vehicle, a typical rubber hose made of a blend of acrylonitrile-butadiene rubber and polyvinyl chloride (NBR/PVC blend, NBR+PVC) or the like has been conventionally used. Such rubber hose has a high vibration-absorbability, easiness of assembly, and an excellent permeation resistance to a fuel (gasoline).

However, recently, in view of global environmental conservation, regulations on restriction of permeation of motor vehicle fuel has been tightened, and demand for fuel permeation resistance is expected to increase more and more in future.

As a countermeasure against that, developed and used is a resin composite hose including a resin layer that is laminated as an inner surface layer on an inner side of an outer rubber layer, has an excellent fuel permeation resistance and serves as a barrier layer.

However, the resin layer as the barrier layer is hard since resin is a material harder than rubber. So, in a hose including the resin layer laminated on an inner side of the outer rubber layer to an extreme end thereof (an axial end of the hose), when the hose is fitted on a mating pipe, a sealing property becomes insufficient due to poor bonding between the mating pipe and the resin layer that defines an inner surface of the hose.

And, since the resin layer defining the inner surface of the hose is hard and has a large deformation resistance, a great force is required for fitting or slipping the hose on the mating pipe. This causes a problem that easiness of connection of the hose and the mating pipe is impaired.

For the purpose of solution of the problem, a hose as shown in FIG. 8 is disclosed in Patent Document 1 below.

In the Figure, reference numeral 200 indicates a resin composite hose, reference numeral 202 indicates an outer rubber layer, and reference numeral 204 is a resin layer that is laminated on an inner surface of the outer rubber layer 202 as a barrier layer.

In the resin composite hose 200, on an end portion thereof to be connected to a mating pipe 206 made of metal, the resin layer 204 is not laminated, and an inner surface of the outer rubber layer 202 is exposed so as to be fitted on the mating pipe 206 directly and elastically in contact relation.

And, in order to prevent a problem that a fuel flowing inside penetrates between the exposed inner surface of the outer rubber layer 202 and the mating pipe 206, and permeates outside through the end portion of the outer rubber layer 202 on which the resin layer 204 is not laminated, in the resin composite hose 200, an annular grooved portion 208 is formed in an end portion of the resin layer 204, a ring-shaped elastic sealing member 210 made of a material such as fluoro rubber (FKM), and having high fuel permeation resistance is attached therein. The resin composite hose 200 is fitted on the mating pipe 206 so as to elastically contact an inner surface of the elastic sealing member 210 with the mating pipe 206.

Meanwhile, reference numeral 212 indicates a bulge portion bulging annularly in a radially outward direction on a leading end portion of the mating pipe 206, reference numeral 214 indicates a hose clamp for fixing the end portion of the outer rubber layer 202 on the mating pipe 206 by tightening in a diametrically contracting direction an outer peripheral surface of the end portion of the outer rubber layer 202 on which the resin layer 204 is not laminated.

In the resin composite hose 200 shown in FIG. 8, the resin layer 204 is not laminated on an end portion of the resin composite hose 200. Therefore, a great resistance is not exerted by the resin layer 204 when the resin composite hose 200 is fitted on the mating pipe 206, and thereby the resin composite hose 200 can be fitted thereon easily with a small force. And, in the end portion of the resin composite hose 200, the inner surface of the outer rubber layer 202 having elasticity contacts directly with the mating pipe 206, and a good sealing property can be provided between the mating pipe 206 and a portion of the resin composite hose 200 fitted thereon.

By the way, the fuel hose typically has a predetermined curved shape since the fuel hose has to be arranged so as not to interfere with peripheral parts and components.

A typical rubber hose of such curved shape is produced in a following manner as disclosed in Patent Document 2 below. An elongated and straight tubular rubber hose body is formed by extrusion, and the elongated and straight tubular rubber hose body is cut to a predetermined length to obtain a straight tubular rubber hose body 216 that is not vulcanized (or is semivulcanized). Then, as shown in FIG. 9, the straight tubular rubber hose body 216 is fitted on a mandrel 218 that is made of metal and has a predetermined curved shape to be deformed into a curved shape. Before molding or fitting, a mold release agent is applied to a surface of the mandrel 218. The curved tubular rubber hose body is vulcanized with being fitted on the mandrel 218 by heating for a predetermined time. When vulcanization is completed, the hose 220 of curved shape is removed from the mandrel 218, and washed, thereby the hose 220 of curved shape as a finished product can be obtained.

However, in case of the resin composite hose 200 shown in FIG. 8, such production method cannot be employed. In case of the resin composite hose 200 shown in FIG. 8, first of all, the outer rubber layer 202 is solely formed by injection molding, and the resin layer 204 is formed on the inner surface of the outer rubber layer 202 so as to follow a shape of the inner surface thereof.

For formation of the resin layer 204 so as to follow the shape of the inner surface of the outer rubber layer 202, electrostatic coating means is suitably applied.

The electrostatic coating is applied in such manner that an injection nozzle is inserted inside a hose, specifically inside the outer rubber layer 202, and resin powder is sprayed from the injection nozzle onto an inner surface of the hose, thereby the inner surface of the outer rubber layer 202 is electrostatically coated with the resin powder.

In the electrostatic coating, a resin membrane is formed in such manner that negatively or positively charged resin powder (typically, negatively charged resin powder) is sprayed from the injection nozzle, and the resin powder flies to and is attached to the inner surface of the outer rubber layer 202 as counter electrode (positive electrode) by electrostatic field.

In steps of such an electrostatic coating, in order to form the resin layer 204 with an intended thickness, usually, more than one cycles of electrostatic coating are performed. Specifically, after the resin powder is attached on the inner surface of the outer rubber layer 202, the resin powder is melted by heating and then cooled. Then, another resin powder is attached on the resin powder by further spraying the resin powder thereto by an electrostatic coating and the another resin powder is melted by heating and then cooled. In this manner, the cycle of electrostatic coating is repeated until the resin layer 204 with an intended wall thickness is formed.

In this case, overall production steps are as follows.

First, the outer rubber layer 202 is formed by injection molding. Then, the outer rubber layer 202 is dried, washed in pretreatment process and dried again. Subsequently, resin powder is attached to an inner surface of the outer rubber layer 202 by electrostatic coating. The resin powder thereon is melted by heating and then cooled. After that, a second cycle of the electrostatic coating (attaching by electrostatic coating, melting and cooling of resin powder) is performed, and this cycle (attaching by electrostatic coating, melting and cooling of resin powder) is repeated to obtain the resin layer 204 with the intended wall-thickness. After the resin layer 204 is completed, a ring-shaped elastic sealing member 210 having fuel permeation resistance is inserted through an axial end of the outer rubber layer 202 to be placed in a predetermined position.

As stated above, a number of steps are required for producing the resin composite hose 200 shown in FIG. 8, and therefore, production cost of the resin composite hose 200 is necessarily increased.

Although the above are described with reference to a fuel hose as an example. The similar problems are anticipated in common to any resin composite hose including a resin layer that defines an inner surface layer on inner side of an outer rubber layer in order to prevent permeation of a transported fluid and serves as a barrier layer having a permeation resistance to the transported fluid.

Accordingly, the inventors of the present invention devised a resin composite hose of a multilayer construction in which an inner rubber layer is further laminated on an inner side of a resin layer as an inner surface layer.

The resin composite hose of the multilayer construction can be provided with permeation resistance (barrier property) to a transported fluid by the resin layer. Further, the inner rubber layer that defines an inner surface of the resin composite hose is elastically deformed when the resin composite hose is fitted on a mating pipe, thereby allows a worker to easily fit the resin composite hose on the mating pipe with a small force, namely to easily connect the resin composite hose to the mating pipe with a small force.

And, since the resin composite hose is connected to the mating pipe so as to elastically contact the inner rubber layer with the mating pipe, a good sealing property can be provided between the mating pipe and a portion of the resin composite hose connected thereto.

And, in the resin composite hose of the multilayer construction, since the resin layer can be formed to an axial edge of the hose, an expensive ring-shaped sealing member 210 having high permeation resistance to a transported fluid as shown in FIG. 8 can be omitted.

In addition, in the resin composite hose of the multilayer construction, since the resin layer can be formed to the axial edge of the hose, it becomes possible to produce the resin composite hose that has a curved shape in the same production method as shown in FIG. 9.

Specifically, a straight tubular hose body is formed with a multilayer construction by successively laminating the inner rubber layer, the resin layer and the outer rubber layer one on another by extrusion. The straight tubular hose body is unvulcanized or semivulcanized. Then, the straight tubular hose body is fitted on a mandrel that has a predetermined curved shape to be deformed, the curved tubular hose body with being fitted on the mandrel is vulcanized by heating, and thereby a resin composite hose of curved shape can be obtained.

In this production method, it becomes possible to produce a resin composite hose at much lower cost than before.

However, the inventors test-produced a resin composite hose of curved shape in this manner, and found that the following problem was caused.

FIG. 10 illustrates this problem concretely.

An elongated tubular hose body is formed by extrusion and cut to a predetermined length whereby a tubular hose body of straight shape indicated at reference numeral 222 in FIG. 10A is obtained. The tubular hose body 222 is unvulcanized (or is semivulcanized) and has a multilayer construction comprising an outer rubber layer 202, a resin layer 204 and an inner rubber layer 224 that defines an inner surface of the tubular hose body 222.

When the tubular hose body 222 is fitted on a mandrel 218 having a curved shape, the resin layer 204 exhibits wave-shaped deformation behavior on inner side of a curved portion of the hose body 222, with the consequence that the outer rubber layer 202 also exhibits similar wave-shaped deformation behavior.

The reason for creation of such wave-shaped deformation is estimated as follows.

When the tubular hose body 222 is fitted on the mandrel 218, on an outer side of the curved portion, a pull-force in an axial direction is exerted on the tubular hose body 222, and the tubular body 222 tends to be elongated in the axial direction (axial direction of the hose) while decreasing in wall thickness on the outer side thereof.

On the other hand, on an inner side of the curved portion, an axial compression force is exerted on the tubular hose body 222, and the tubular hose body 222 tends to be forcibly contracted in the axial direction while slightly increasing in wall thickness.

When a hose does not include the resin layer 204 and comprises a rubber layer alone (or a rubber layer and a reinforcing layer), the hose can comply with deformation by pull-out force and deformation under compression, namely, the tubular hose body 222 can be deformed so as to follow the curved shape of the mandrel 218 sufficiently without creating wave-shaped deformation as stated above.

However, in a resin composite hose having the resin layer 204, the resin layer 204 cannot be deformed so as to follow the curved shape of the mandrel 218 favorably, in particular, on the inner side of the curved portion of the resin layer 204, an excess length or loosening is created due to dimensional contraction caused by compression in the axial direction, slack in the axial direction is created thereon, and as a result, wave-shaped deformation is created as shown in FIG. 10B.

[Patent Document 1] JP-A, 2002-54779

[Patent Document 2] JP-A, 11-90993

Under the foregoing circumstances, it is an object of the present invention to provide a resin composite hose that can prevent wave-shaped deformation behavior in a resin layer and has an excellent permeation resistance to a transported fluid, and to provide a method for producing the same.

### SUMMARY OF THE INVENTION

According to the present invention, there is provided a novel resin composite hose of curved shape. The resin composite hose of curved shape includes at least one curved portion. Or the resin composite hose of curved shape includes at least one curved portion at a certain axial position thereof or at one axial position thereof. The resin composite hose has a multilayer construction, and comprises a resin layer having permeation resistance to a transported fluid and serving as a barrier layer, an inner rubber layer as an inner surface layer on an inner side of the resin layer and an outer rubber layer on an outer side of the resin layer. The resin composite hose is formed generally or overall in a shape as follows. The resin composite hose has one axial end that is larger in diameter than the other axial end of the resin composite hose. The curved portion is formed in a shape of continuously, for example, and progressively increasing diameter from a curve beginning end of the curved portion with a small diameter near the other axial end of the resin composite hose to a curve terminal end of the curved portion with a large diameter near the one axial end thereof. When the resin composite hose includes a plurality of curved portions, it is not necessary to form all of the curved portions in shapes of continuously increasing diameters from curve beginning ends to curve terminal ends.

According to one aspect of the present invention, in the resin composite hose of curved shape, a plurality of the curved portions are formed or a plurality of the curved portions are formed at certain axial positions or a plurality of the axial positions. Each of the curved portions is formed in a shape of continuously, for example, and progressively increasing diameter from the curve beginning end to the curve terminal end. The plurality of the curved portions are arranged in order of increasing diameter from the other axial end of the resin composite hose toward the one axial end thereof. For example, the curved portions are arranged such that the curved portion near the one axial end is larger in diameter than the curved portion near the other axial end in any two adjacent curved portions.

According to the present invention, there is provided a novel method for producing the resin composite hose of curved shape. The method comprises a step of forming a straight tubular hose body by successively laminating the inner rubber layer, the resin layer and the outer rubber layer on one another by extrusion, a step of preparing a mandrel having a shape corresponding to a shape of inner surface of the resin composite hose of curved shape, a step of relatively fitting the straight tubular hose body on the mandrel and deforming the straight tubular hose body to obtain a curved tubular hose body, and a step of vulcanizing the curved tubular hose body to obtain the resin composite hose of curved shape.

The straight tubular hose body is multi-layered, plastically deformable, and further unvulcanized or semivulcanized.

As stated above, the resin composite hose has a multilayer construction comprising the resin layer, the inner rubber layer as the inner surface layer on the inner side of the resin layer, and the outer rubber layer on the outer side of the resin layer. The resin composite hose includes at least one curved portion at a certain axial position thereof. The resin composite hose has one axial end and the other axial end. The one axial end of the resin composite hose is larger in diameter than the other axial end thereof. And, the curved portion has a curve beginning end near the other axial end of the resin composite hose and a curve terminal end near the one axial end of the resin composite hose. The curve beginning end is smaller in diameter than the curve terminal end. The curved portion is formed in the shape of continuously, for example, progressively increasing diameter from the curve beginning end (an end of the curved portion near the other axial end of the resin composite hose) with a small diameter to the curve terminal end (an end of the curved portion near the one axial end of the resin composite hose) with a large diameter.

According to the present invention, the curved portion has a shape of continuously increasing diameter. When the unvulcanized or semivulcanized straight tubular hose body is fitted on the mandrel having the corresponding curved shape to provide the tubular hose body with the curved shape, the resin layer does not exhibit wave-shaped deformation behavior on an inner side as well as on an outer side of the curved portion, and therefore, the tubular hose body can be provided with a curved shape as intended through an entire length thereof.

The reason why wave-shaped deformation is created on the inner side of the curved portion as stated above is because the inner side of the curved portion is contracted in the axial direction and thereby an excess length, slack or loosening in the axial direction is created.

Here, according to the present invention, the curved portion has a shape of continuously increasing diameter along the axial direction of the resin composite hose. Therefore, during fitting of the tubular hose body on the mandrel, an excess length, namely slack or loosening created on the inner side of the curved portion is absorbed, offset or eliminated by increasing diameter of the curved portion. That is, slack or loosening is absorbed or offset by elongation of the resin layer in a circumferential direction due to forcedly increasing diameter of the resin layer. As a result, the resin layer is prevented from above wave-shaped deformation behavior on the inner side of the curved portion, and thereby the rubber layer is also prevented from deformation behavior.

Meanwhile, as the case may be, a fluid transporting hose such as a fuel hose has one axial end that is larger in diameter than the other axial end thereof, for the purpose of connecting between mating pipes of different diameters. The present invention is applied to such hose, and the resin composite hose of the present invention takes advantage of a design having different diameters between one and the other axial end thereof.

According to one aspect of the present invention, the resin composite hose has a plurality of the curved portions at certain axial positions, and the plurality of the curved portions are arranged in order of increasing diameter from the other axial end of the resin composite hose toward the one axial end thereof. The curved portions have different diameters, respectively. The curved portions are arranged such that the curved portion near the one axial end is larger in diameter than the curved portion near the other axial end in any two adjacent curved portions. In this configuration, above wave-shaped deformation behavior can be favorably prevented on each of the curved portions. At the same time, during production procedure, the unvulcanized or semivulcanized straight tubular hose body can be fitted and deformed on the mandrel favorably with no difficulty. And, after vulcanizing step, the resin composite hose can be smoothly removed relatively from the mandrel with no difficulty.

The method for producing the resin composite hose of curved shape according to the present invention comprises a step of forming an unvulcanized or semivulcanized plastically deformable straight tubular hose body of multilayer construction by successively laminating the inner rubber layer, the resin layer and the outer rubber layer on one another by extrusion, a step of preparing a mandrel having the curved shape, a step of relatively fitting the straight tubular hose body on the mandrel and deforming the straight tubular hose body to obtain a curved tubular hose body, and a step of vulcanizing the curved tubular hose body to obtain the resin composite hose of curved shape. In this production method, above resin composite hose of curved shape can be easily produced in a small number of steps, and therefore can be provided at much lower cost than before.

Now, the preferred embodiments of the present invention will be described in detail with reference to the drawings.

### BRIEF DESCRIPTION OF THE DRAWINGS

FIG. 1 is a perspective view of a resin composite hose of curved shape according to one embodiment of the present invention, showing partly broken away.

FIG. 2A is an overall sectional view of the resin composite hose of curved shape.

FIG. 2B is an overall side view of the resin composite hose of curved shape.

FIG. 3A is an enlarged view of a curved portion of the resin composite hose of curved shape.

FIG. 3B is a view of sections of the curved portion of FIG. 3A.

FIG. 4 is a view showing a relevant step of production method of the resin composite hose of curved shape.

FIG. 5A is a view for explaining a disadvantage of a conventional resin composite hose.

FIG. 5B is a view for explaining an advantage of the resin composite hose of curved shape of the present invention.

FIG. 6 is a perspective view of a modified resin composite hose of curved shape according to the present invention.

FIG. 7 is a perspective view of another modified resin composite hose of curved shape according to the present invention.

FIG. 8A is a sectional view of a conventional resin composite hose.

FIG. 8B is an enlarged view of a part of the conventional resin composite hose of FIG. 8A.

FIG. 9 is a view showing a typical production method for producing a conventional resin composite hose of curved shape.

FIG. 10A is a view showing a multilayer construction of a tubular hose body.

FIG. 10B is a view for explaining a failure occurred in the conventional resin composite hose of curved shape.

### DETAILED DESCRIPTIONS OF PREFERRED EMBODIMENTS

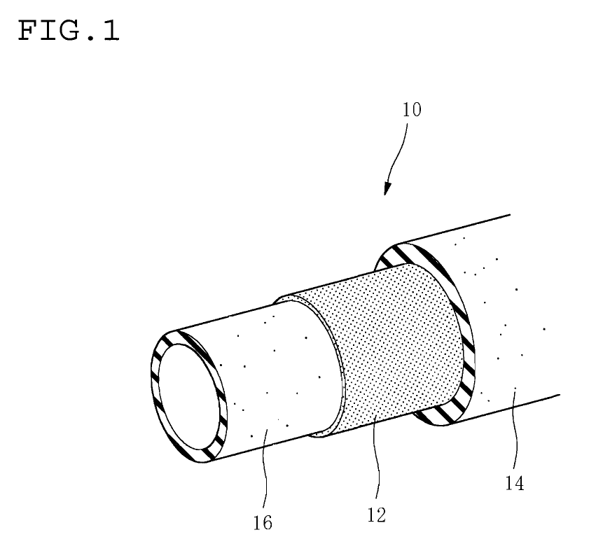

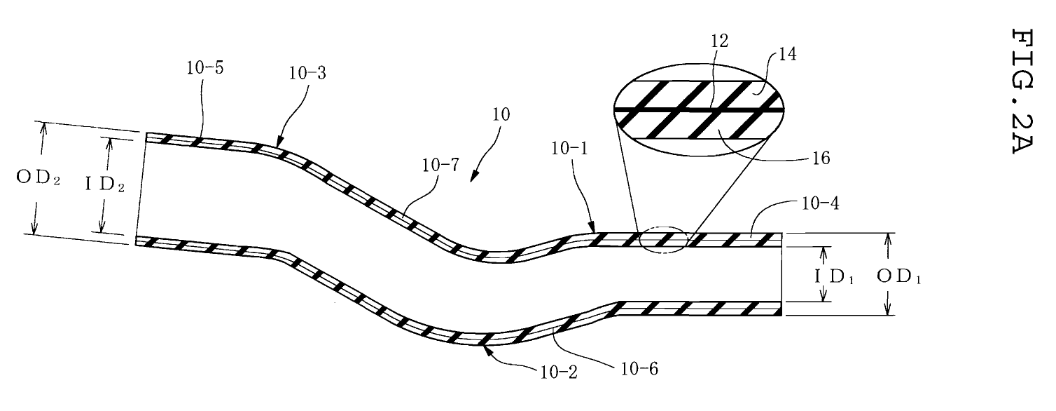

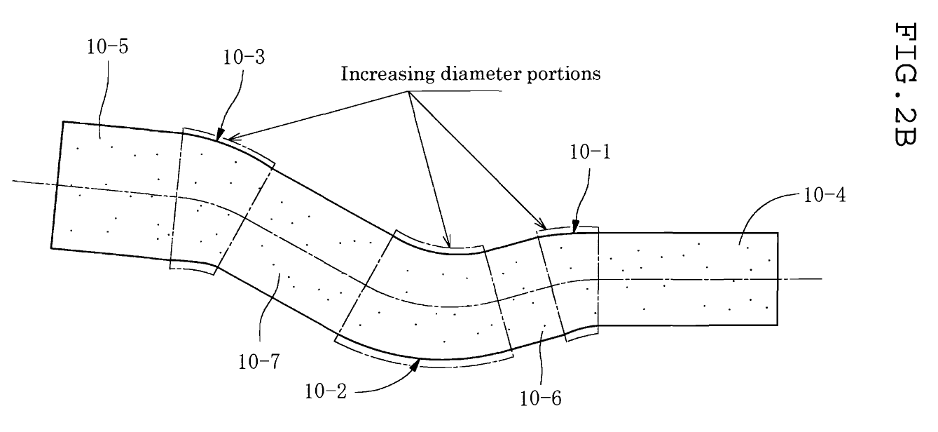

In FIGS. 1 and 2, reference numeral 10 indicates a resin composite hose (hereinafter simply referred to as a hose) as a fluid transporting hose that is suitable for a hose such as a fuel hose. The hose 10 has multilayer construction comprising a resin layer 12 as a barrier layer having a permeation resistance to a transported fluid, an outer rubber layer 14 on an outer side of the resin layer 12, and an inner rubber layer 16 as an inner surface layer on an inner side of the resin layer 12.

Here, the resin layer 12 as a middle layer is formed to extend from one axial end to the other axial end of the hose 10, or to extend from one axial edge portion to the other axial edge portion thereof.

In this embodiment, acrylonitrile butadiene rubber (NBR) is used for the inner rubber layer 16, fluorothermoplastic copolymer consisting of at least three monomers, tetrafluoroethylene, hexafluoropropylene, and vinylidene fluoride (THV) is used for the resin layer 12, and NBR+PVC is used for the outer rubber layer 14.

Here, bonding strength between the layers (one and adjacent layers) equal to or greater than 10N/25 mm, and the layers are bonded to each other firmly. In each of samples evaluated with respect to bonding strength, peel-off does not occur on an interface of each layer, but a parent material is destroyed. The resin layer 12 and the inner rubber layer 16, the resin layer 12 and the outer rubber layer 14 are bonded to one another by vulcanizing bonding, but may be also bonded to one another by adhesive.

The inner rubber layer 16, the resin layer 12 and the outer rubber layer 14 may be made or constructed of the following materials, as well as the combination of the above materials.

Specifically, for the inner rubber layer 16, materials such as NBR (acrylonitrile content is equal to or greater than 30% by mass), NBR+PVC (acrylonitrile content is equal to or greater than 30% by mass), FKM, hydrogenated acrylonitrile butadiene rubber (H-NBR) may be suitably used.

A wall-thickness of the inner rubber layer 16 may be around 1.0 to 2.5 mm.

For the resin layer 12 as a middle layer, materials such as THV, polyvinylidene fluoride (PVDF), ethylene-tetrafluoroethylene copolymer (ETFE), polychlorotrifluoroethylene (CTFE), ethylene-vinyl alcohol (EVOH), polybutylene naphthalate (PBN), polybutylene terephtharate (PBT), polyphenylene sulfide (PPS) are suitably used.

A wall thickness of the resin layer 12 may be about 0.03 to 0.3 mm.

THV is flexible compared to EVOH and PVDF, and suitable for a barrier material for a hose with layers of resin and rubber. In comparison with Polytetrafluoroethylene (PTFE) and EVOH, ETFE and THV are easily extruded, easily laminated to a rubber, and have excellent adhesion to rubber. On the other hand, PBN and PBT are less flexible compared to THV. However, PBN and PBT are excellent in fuel permeation resistance, and can be thin-walled compared to THV. Therefore, a flexible hose can be formed also from PBN and PBT, similarly from THV.

On the other hand, for the outer rubber layer 14, materials such as NBR+PVC, epichlorohydrin-ethylene oxide copolymer (ECO), chlorosulponated polyethylene rubber (CSM), NBR+acrylic rubber (NBR+ACM), NBR+ethylene-propylene-diene rubber (NBR+EPDM), and EPDM may be suitably used.

A wall thickness of the outer rubber layer 14 may be about 1.0 to 3.0 mm.

The hose 10 entirely has a curved or bent shape, namely has three curved portions 10-1, 10-2 and 10-3 at three axial positions of the hose 10, as shown in FIG. 2.

The hose 10 has straight portions or straight tubular portions 10-4, 10-5, 10-6 and 10-7 that are defined by axially opposite end portions of the hose 10, a portion between the curved portions 10-1 and 10-2, and a portion between the curved portions 10-2 and 10-3, respectively.

Meanwhile, every cross-section of the hose 10 along its axis is a circle (perfect circle).

In the hose 10, one axial end is larger in diameter than the other axial end. Specifically, an inner diameter ID₂ and an outer diameter OD₂ of one axial end of the hose 10 are larger than an inner diameter ID₁ and an outer diameter OD₁ of the other axial end thereof, respectively.

In this embodiment, in the hose 10, each of the curved portions 10-1, 10-2 and 10-3 is formed in a shape of progressively and continuously increasing in diameter from a curve beginning end with a small diameter near the other axial end of the hose 10 toward a curve terminal end with a large diameter near one axial end thereof.

Further, the curved portions 10-1, 10-2 and 10-3 are arranged in order of increasing both an inner diameter and an outer diameter. Namely, the inner diameter and the outer diameter of the curved portion 10-2 are larger than those of the curved portion 10-1, and the inner diameter and the outer diameter of the curved portion 10-3 are larger than those of the curved portion 10-2.

Specifically, in this embodiment, an inner diameter ID₂ of one axial end of the hose 10 increases by 30% with respect to an inner diameter ID₁ of the other axial end thereof. Namely, as a result of increasing diameter of each of the curved portions 10-1, 10-2 and 10-3, the inner diameter ID₂ is larger than the inner diameter ID₁ by 30%.

Namely, in the curved portion 10-1, an inner diameter is equal to ID₁ at a curve beginning end and increases by about 10% at a curve terminal end.

In the curved portion 10-2, an inner diameter is equal to the inner diameter of the curve terminal end of the curved portion 10-1 at a curve beginning end, and increases by about 10% at a curve terminal end.

Further, in the curved portion 10-3, an inner diameter is equal to the inner diameter of the curve terminal end of the curved portion 10-2 at a curve beginning end, increases by about 10% at a curve terminal end, and finally becomes equal to an inner diameter ID₂ of the one axial end.

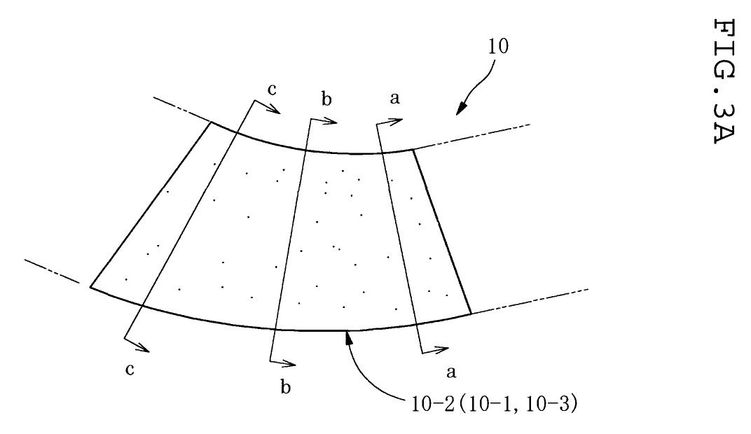

Here, as shown in FIG. 3, each of the curved portions 10-1, 10-2 and 10-3 increases in an inner diameter and an outer diameter from its curve beginning end toward its curve terminal end, with keeping every cross-section a circle along its axis.

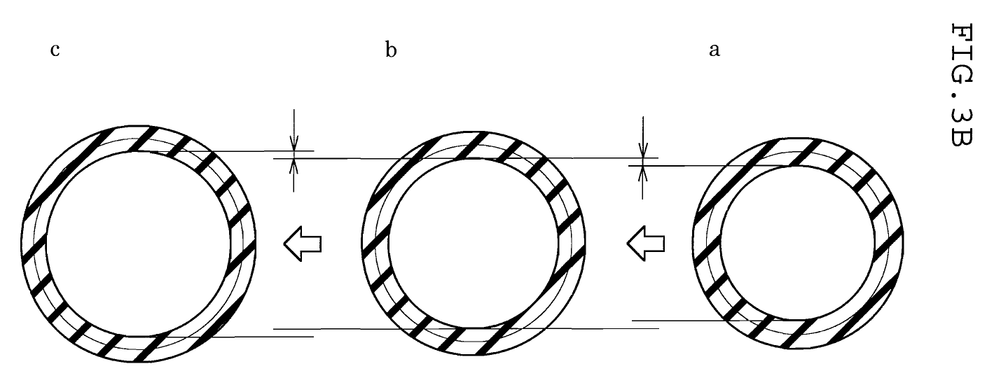

FIG. 4 shows a relevant step in the production method of the above hose 10 of curved shape.

In the Figure, reference numeral 30 indicates a metal mandrel that has an outer surface of a curved shape corresponding an inner surface of the hose 10.

Specifically, the mandrel 30 has curved portions (increasing diameter portions) 30-1, 30-2 and 30-3, and straight tubular shaped portions 30-4, 30-5, 30-6 and 30-7, corresponding to the curved portions 10-1, 10-2 and 10-3, and the straight tubular portions 10-4, 10-5, 10-6 and 10-7 of the hose 10.

In the production method according to this embodiment, first, the inner rubber layer 16, the resin layer 12 and the outer rubber layer 14 are successively laminated on one another by extrusion to obtain an elongated straight tubular body. The elongated straight tubular body is cut to a certain length, and thereby a straight tubular hose body 10A that is plastically deformable and unvulcanized is obtained. This straight tubular hose body 10A has a diameter equal to a small diameter of the other axial end of the hose 10 to be produced. The straight tubular hose body 10A has, for example, an identical diameter along its entire length.

The straight tubular hose body 10A may be semivulcanized afterward. As the case may be, the straight tubular hose body 10A may have a diameter smaller than the small diameter of the other axial end of the hose 10 to be produced.

Then the straight tubular hose body 10A is fitted on the mandrel 30 and is deformed into a shape following to that of the mandrel 30. And a curved tubular hose body with the mandrel 30 therein is put in a vulcanizing can, and is vulcanized by heating in a predetermined time to obtain a vulcanized curved tubular hose body (the hose 10 of curved shape). The vulcanized curved tubular hose body (the hose 10 of curved shape) with the mandrel 30 therein is taken out of the vulcanizing can, and the mandrel 30 is removed relatively from the vulcanized curved tubular hose body (the hose 10 of curved shape), thereby the hose 10 of curved shape shown in FIG. 2 is obtained.

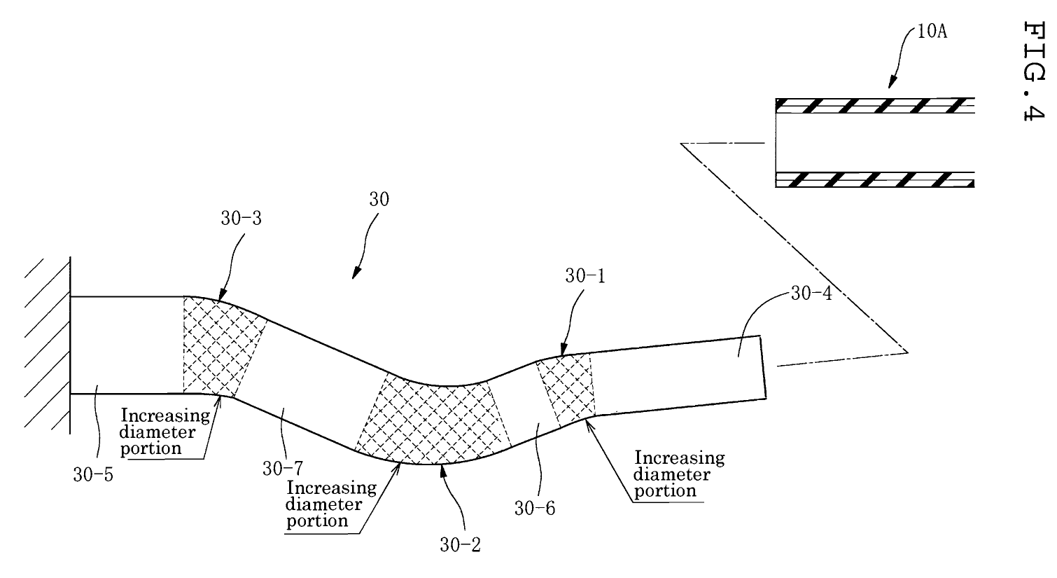

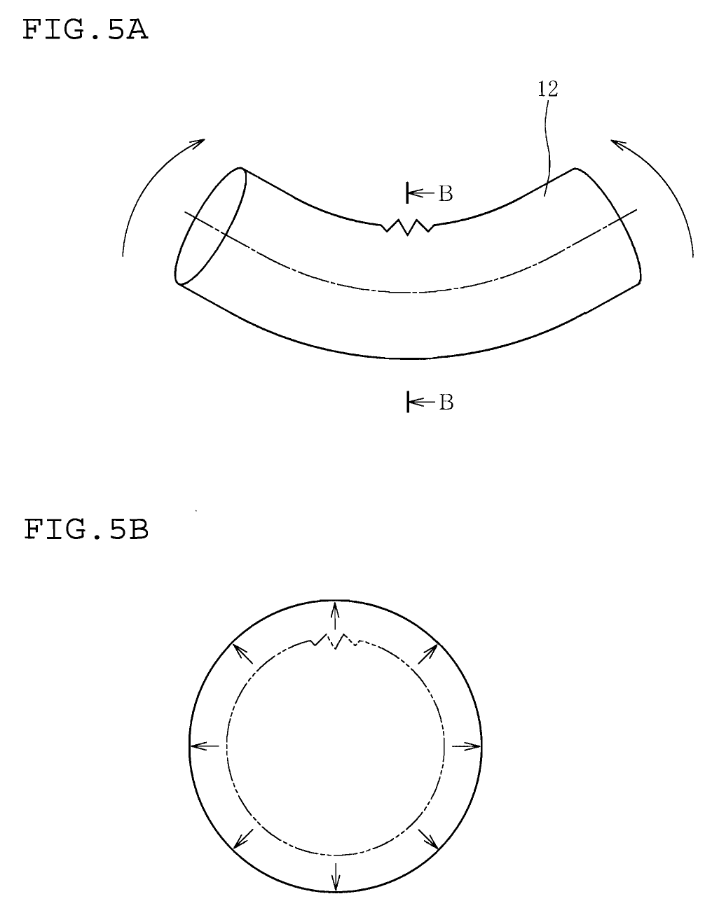

In case that a mandrel does not progressively and continuously increase in diameter at curved portions and has a uniform outer diameter along its entire length unlike the mandrel 30 shown in FIG. 4, namely in case that a finished vulcanized hose has uniform inner and outer diameters along its entire axial length, when a straight tubular hose body 10A before vulcanized is fitted on the mandrel of curved shape, the resin layer 12 exhibits a wave-shaped deformation behavior on an inner side of a curved portion of the mandrel as shown in FIG. 5 (A).

On the contrary, in the present embodiment, the mandrel 30 progressively and continuously increases in diameter on the curved portions 30-1, 30-2 and 30-3. Therefore, when the straight tubular hose body 10A is fitted on the mandrel 30 and is deformed, the resin layer 12 does not exhibit wave-shaped deformation behavior on an inner side of each curved portion as well as on an outer side thereof. So, the straight tubular hose body 10A can be entirely formed favorably into a curved shape as intended.

Since the hose 10 progressively and continuously increases in diameter along its axis on each of the curved portions 10-1, 10-2 and 10-3, as shown in FIG. 5 (B), an excessive length, slack or loosening created on an inner side of the curved portions is absorbed by an elongation in a circumferential direction, or offset with the elongation in the circumferential direction based on continuous increase in diameter of the curved portions, namely forced diametrical expansion of the resin layer 12. As a result, the above wave-shaped deformation behavior can be favorably prevented from being created on the inner side of each of the curved portions 10-1, 10-2 and 10-3.

As stated, according to this embodiment, the hose 10 can be favorably formed entirely in a curved shape as intended without exhibiting a wave-shaped deformation behavior.

In the procedure of producing the hose 10, the straight tubular hose body 10A can be favorably fitted and deformed on the mandrel 30 with no difficulty. And, the tubular hose body after vulcanized (the hose 10) can be easily removed relatively from the mandrel 30 by a small pull force. And, the hose 10 of curved shape can be easily produced in a small number of steps, and thereby produced at much lower cost than before.

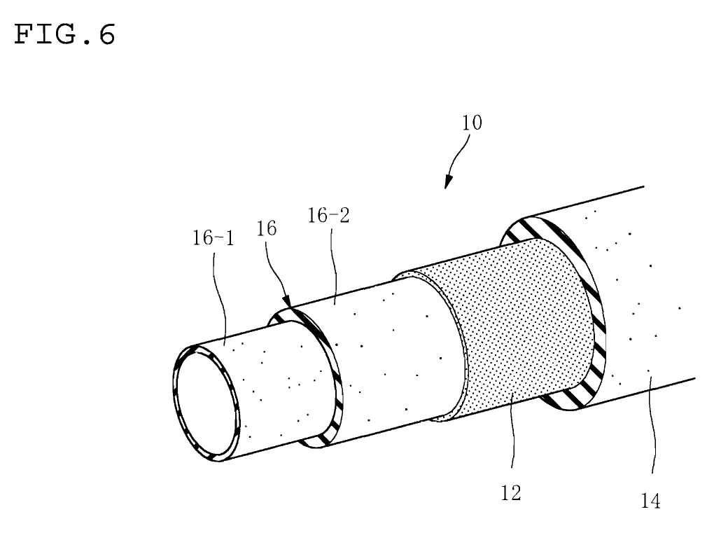

In the hose 10 of the above embodiment, the inner rubber layer 16 comprises a single layer. However, as shown in FIG. 6, the inner layer 16 may have a two-layer construction that comprises a first layer (rubber layer) 16-1 defining an innermost surface and a second layer (rubber layer) 16-2 on an outer side of the first layer 16-1.

In this four-layer hose 10, bonding strength between the layers (one and adjacent layers) is equal to or greater than 10N/25 mm, and the layers are bonded to one another firmly. In each of samples evaluated with respect to bonding strength, peel-off does not occur on an interface of each layer, but a parent material is destroyed. The resin layer 12 and the second layer 16-2, the resin layer 12 and the outer rubber layer 14 are bonded to one another by vulcanizing bonding, respectively, but may be also bonded to one another by adhesive.

In this four-layer hose 10, a material for each layer may be combined as follows.

For the first layer 16-1, materials such as FKM, NBR (acrylonitrile content is equal to or greater than 30% by mass), NBR+PVC (acrylonitrile content is equal to or greater than 30% by mass) may be suitably used.

A wall-thickness of the first layer 16-1 may be around 0.2 to 1.0 mm.

On the other hand, for the second layer 16-2, materials such as NBR (acrylonitrile content is equal to or greater than 30% by mass) or NBR+PVC (acrylonitrile content is equal to or greater than 30% by mass) may be suitably used.

A wall-thickness of the second layer 16-2 may be around 1 to 2 mm.

The resin layer 12 in the middle of the layers and the outer rubber layer 14 may be formed as stated above.

In particular, preferably, FKM having an excellent gasoline permeation resistance is used for the first layer 16-1. By making the first layer 16-1 of FKM, can be ensured not only a fuel permeation restraining function served by the resin layer 12 but also an end permeation preventing function for effectively preventing that a fuel permeates through an inner surface layer, then permeates out of an axial edge of the hose 10 at an axial end portion of the hose 10 to which a mating member such as a mating pipe is connected. For the purpose of ensuring easy connection of the hose 10 and the mating pipe or the like, the inner rubber layer 16 has a wall-thickness of equal to or greater than 1 mm. However, when the inner rubber layer 16 is entirely made of FKM, a cost of the hose 10 is increased. So, due to cost reason, for the second layer 16-2, inexpensive NBR (acrylonitrile content is equal to or greater than 30% by mass) or inexpensive NBR+PVC (acrylonitrile content is equal to or greater than 30% by mass) is used.

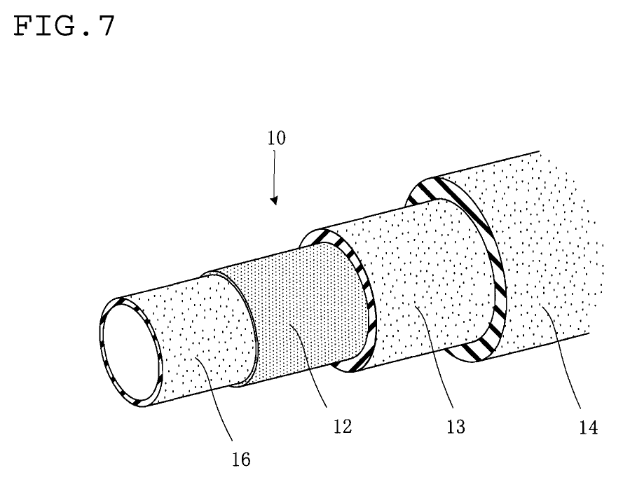

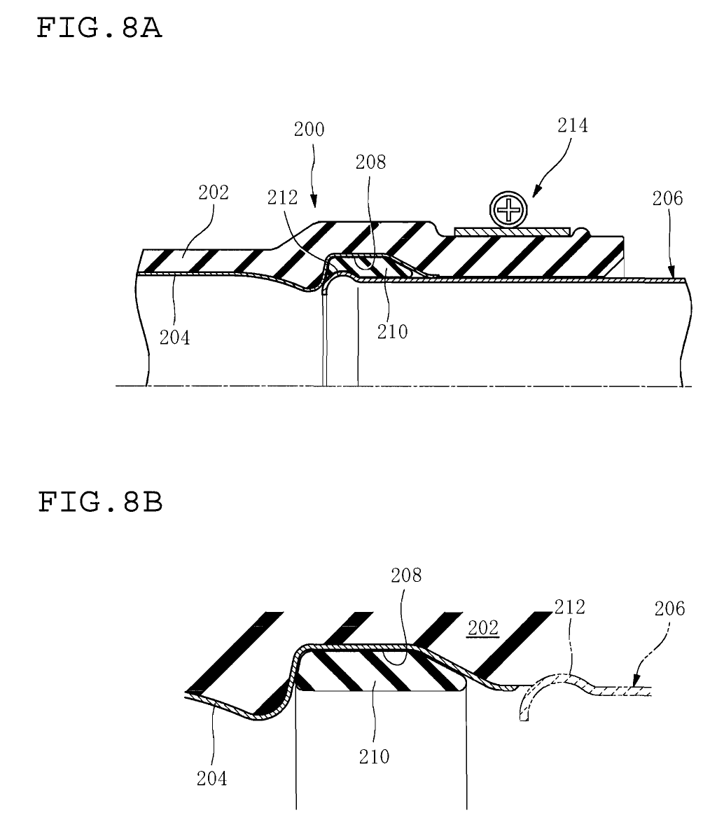

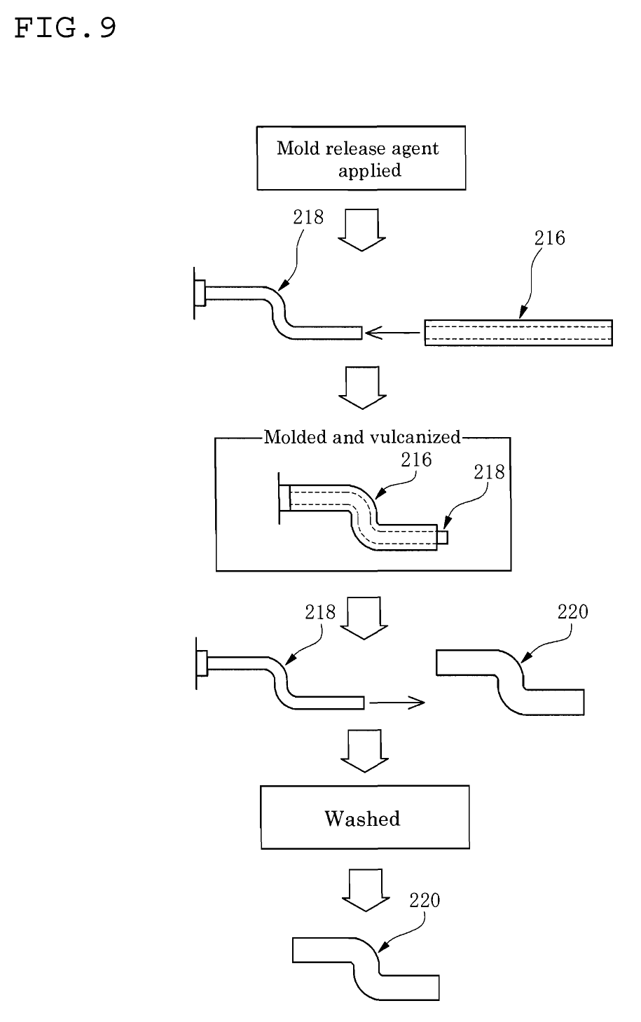

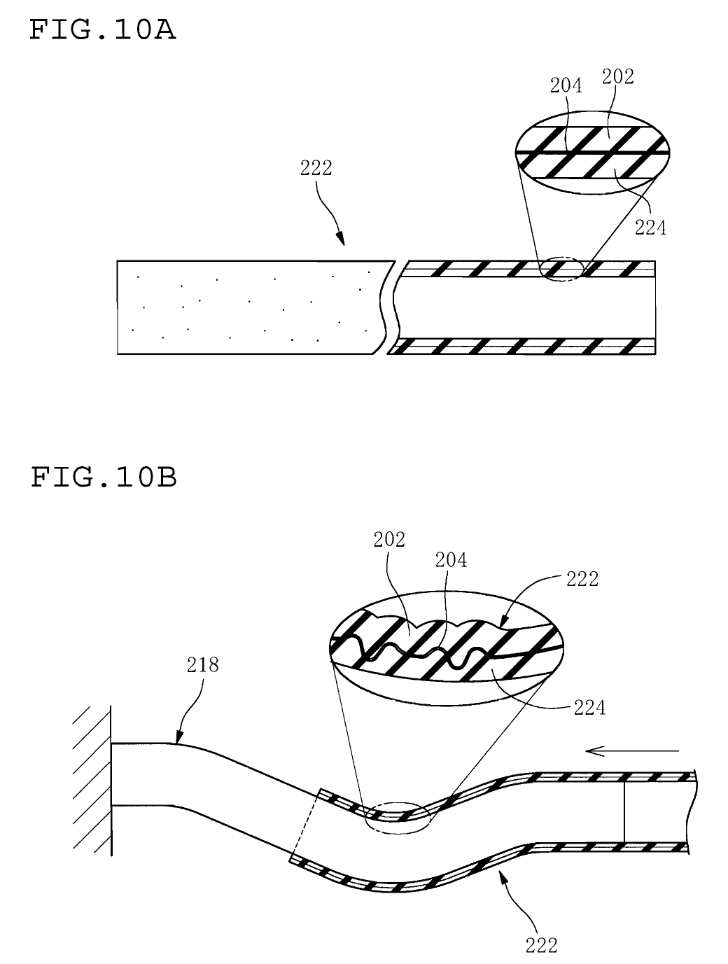

As shown in FIG. 7, the hose 10 may have a multilayer construction including a middle rubber layer 13 between the resin layer 12 and the outer rubber layer 14 (the middle rubber layer 13 may be regarded as a first layer of an outer rubber layer and the outer rubber layer 14 may be regarded as a second layer of the outer rubber layer).

In the hose 10 having the four-layer construction of FIG. 7, bonding strength between the layers (one and adjacent layers) is equal to or greater than 10N/25 mm, and the layers are bonded to one another firmly. In each of samples evaluated with respect to bonding strength, peel-off does not occur on an interface of each layer, but a parent material is destroyed. The resin layer 12 and the inner rubber layer 16, the resin layer 12 and the middle rubber layer 13 are bonded to one another by vulcanizing bonding, respectively, but may be also bonded to one another by adhesive.

In the hose 10 having the four-layer construction of FIG. 7, the inner rubber layer 16, the resin layer 12, the middle rubber layer 13 and the outer to rubber layer 14 may be constructed in combination of the following materials.

For the inner rubber layer 16, materials such as FKM, NBR (acrylonitrile content is equal to or greater than 30% by mass), NBR+PVC (acrylonitrile content is equal to or greater than 30% by mass) may be suitably used.

A wall-thickness of the inner rubber layer 16 may be about 0.2 to 1.0 mm.

For the resin layer 12 as a middle layer, fluoro type resin such as THV, PVDF or ETFE, and polyamide (PA) or nylon resin such as PA6, PA66, PA11 or PA12 may be suitably used.

A wall-thickness of the resin layer 12 may be about 0.03 to 0.3 mm.

On the other hand, for the middle rubber layer 13, NBR (acrylonitrile content is equal to or greater than 30% by mass), NBR+PVC (acrylonitrile content is equal to or greater than 30% by mass), ECO, CSM, NBR+ACM, NBR+EPDM, butyl rubber (IIR), EPDM+IIR, or EPDM may be suitably used.

A wall-thickness of the middle rubber layer 13 may be about 0.2 to 2.0 mm.

For the outer rubber layer 14, materials such as NBR (acrylonitrile content is equal to or greater than 30% by mass), NBR+PVC (acrylonitrile content is equal to or greater than 30% by mass), ECO, CSM, NBR+ACM, NBR+EPDM, IIR, EPDM+IIR, and EPDM may be suitably used.

A wall-thickness of the outer rubber layer 14 may be about 1 to 3 mm.

Meanwhile, total wall-thickness, namely a suitable wall-thickness of the hose 10 of FIG. 7 is about 2.5 to 6.0 mm. When the wall-thickness of the hose 10 is less than 2.5 mm, a gasoline permeation resistance of the hose 10 is insufficient. When the wall-thickness of the hose 10 is greater than 6 mm, a flexibility of the hose 10 is insufficient.

Here, when the outer rubber layer 14 (the second layer of the outer rubber layer) or the middle rubber layer 13 (the first layer of the outer rubber layer) is made of IIR or EPDM+IIR, the outer rubber layer 14 or the middle rubber layer 13 is provided with a gasoline fuel permeation resistance, and serves as a barrier layer since IIR and EPDM+IIR have alcohol resistance. Therefore, even when the resin layer 12 is formed thin-walled to enhance flexibility or elasticity of the hose 10, gasoline fuel permeation resistance of the hose 10 does not become insufficient. And, even when the resin layer 12 is made of inexpensive PA or nylon resin instead of fluoro type resin having an excellent gasoline permeation resistance, sufficient gasoline fuel permeation resistance of the hose 10 can be maintained.

Then, the test samples of hoses including middle rubber layers made of IIR are evaluated with respect to a gasoline permeation resistance and the results are shown in Table 1.

The evaluation is conducted in the following manner. Four test samples or specimens of hoses (A), (B), (C) and (D), each having an inner diameter of 24.4 mm, a wall-thickness of 4 mm, and a length of 300 mm, are prepared. The test sample (A) has a three-layer construction including an inner rubber layer of NBR, a resin layer of THV (specifically, THV815: THV815 is a product number of a product commercially available under the trademark Dyneon from Dyneon, LLC), and an outer rubber layer of NBR+PVC, the test sample (B) has a four-layer construction including an inner rubber layer of NBR, a resin layer of THV (THV815, wall-thickness 0.11 mm), a middle rubber layer of IIR (a first layer of an outer rubber layer) and an outer rubber layer of NBR+PVC (a second layer of the outer rubber layer), the test sample (C) has a four-layer construction including an inner rubber layer of NBR, a resin layer of THV (THV815, wall-thickness of 0.08 mm), a middle rubber layer of IIR (a first layer of an outer rubber layer) and an outer rubber layer of NBR+PVC (a second layer of the outer rubber layer), and the test sample (D) has a four-layer construction including an inner rubber layer of NBR, a resin layer of nylon (PA11), a middle rubber layer of IIR (a first layer of an outer rubber layer) and an outer rubber layer of NBR+PVC (a second layer of the outer rubber layer). In the columns of “Specimen” and “Wall-thickness” of Table 1, materials and wall-thicknesses only of the resin layers and the middle rubber layers (materials and wall-thicknesses only of the resin layer and the outer rubber layer in the test sample (A)) are indicated, respectively. In each of the test samples (A), (B), (C) and (D), a round-chamfered metal pipe of an outer diameter of 25.4 mm provided with two bulge portions (maximum outer diameter of 27.4 mm) is press-fitted in each end portion thereof, and one of the metal pipes is closed with a plug. And, a test fluid (Fuel C+ethanol (E) 10 volume %) is supplied in each of the test samples (A), (B), (C) and (D) via the other of the metal pipes, and the other of the metal pipes is closed with a plug of screw type to enclose the test fluid in each of the test samples (A), (B), (C) and (D). Then, each of the test samples (A), (B), (C) and (D) is allowed to stand at 40° C. for 3000 hours (the test fluid is replaced every 168 hours). Then, permeation amount of carbon hydride (HC) is measured with respect to each of the test samples (A), (B), (C) and (D) every day for three days based on DBL (Diurnal Breathing Loss) pattern by a SHED (Sealed Housing for Evaporative Detection) method according to CARB (California Air Resources Board). With regard to each of the test samples (A), (B), (C) and (D), applied is a permeation amount on a day when a maxim permeation amount is detected.

TABLE 1

| | A | B | C | D |
|---|---|---|---|---|
| Specimen | *¹⁾THV815/ | THV815/IIR | THV815/IIR | PA11/IIR |
| | NBR + PVC | | | |
| Wall-thickness | 0.11/2.16 | 0.11/1.9 | 0.08/1.9 | 0.20/1.9 |
| (mm) | | | | |
| Permeation | 4.2 | 2.7 | 4.2 | 3.8 |
| amount | | | | |
| (mg/hose) | | | | |

Note:
*¹⁾THV815 is a product number of a product commercially available under the trademark Dyneon from Dyneon LLC.

As appreciated from the results of Table 1, the permeation amount of HC is the same, namely 4.2 mg/hose, between the test sample (A) including the outer rubber layer made of NBR+PVC and the test sample (C) including the middle rubber layer made of IIR. However, in terms of a wall-thickness of the resin layer, the test sample (A) includes the resin layer of a wall-thickness 0.11 mm that is greater than the wall-thickness 0.08 mm of the test sample (C). Therefore, when a hose includes a rubber layer made of IIR, an equivalent gasoline permeation resistance can be ensured by constructing a resin layer with a wall-thickness decreased by about 30%. Between the test sample (A) including the outer rubber layer made of NBR+PVC and the test sample (B) including the middle rubber layer made of IIR, a wall-thickness of the resin layer is the same, 0.11 mm. However, the permeation amount of HC is different, namely 4.2 mg/hose in the test sample (A) and 2.7 mg/hose in the test sample (B). When a hose includes a resin layer of an identical wall-thickness, HC permeation resistance can be decreased by about 35% by making a rubber layer of IIR. Further, in the test sample (D) including the middle rubber layer made of IIR and the resin layer made of PA11, a permeation amount of HC can be decreased by about 10% compared to the test sample (A) by increasing the wall-thickness of the resin layer by about 80%. This evaluation can basically apply also to a hose including a middle rubber layer made of EPDM+IIR.

As such, when a hose is constructed with four layers by combining materials suitably selected from the above, a permeation resistance to a transported fluid can be further enhanced, a resistance to a sour gasoline can be further enhanced, or a heat resistance or a resistance to alcohol gasoline can be also enhanced in a fuel hose. And, flexibility of the hose can be improved by decreasing a wall-thickness of a resin layer of the hose.

By the way, in the hose 10 shown in FIG. 1, FIG. 6 or FIG. 7, a rubber hardness degree of the outer rubber layer 14 (in the hose 10 of FIG. 7, the middle rubber layer 13 and the outer rubber layer 14) may be set equal to or greater than that of the inner rubber layer 16 (in the hose 10 of FIG. 6, the first layer 16-1 and the second layer 16-2), and the permanent elongation or permanent elongation rate of the inner rubber layer 16 (in the hose 10 of FIG. 6, the first layer 16-1 and the second layer 16-2) may be set equal to or less than 90%. Namely, typically, in a fuel hose of multilayer laminated construction comprising a resin layer with fuel permeation resistance as a barrier layer, an inner rubber layer as an inner surface layer on an inner side of the resin layer and an outer rubber layer on an outer side of the resin layer, the rubber hardness degree of the outer rubber layer may be set equal to or greater than that of the inner rubber layer, and a permanent elongation or permanent elongation rate of the inner rubber layer may be set equal to or less than 90%. And, the permanent elongation of the inner rubber layer is an index indicating its fatigue property or sag property. The permanent elongation is determined (stipulated) as follows. Here, the permanent elongation means a permanent elongation of a test specimen according to Japan Industrial Standard (JIS) K6262. The test specimen in a form of No. 7 according to JIS K6251 is taken from a product or a sheet sample, is stretched by 50% of its original length constantly, and is allowed to stand at 100° C. for 72 hours. After that, its permanent elongation rate is measured.

By setting the rubber hardness degree of the outer rubber layer equal to or greater than the rubber hardness degree of the inner rubber layer, when the outer rubber layer is tightened by the hose clamp in a diametrically contracting direction for connecting the hose to a mating pipe, a tightening force can be favorably transmitted to the inner rubber layer, thereby the hose can be connected to the mating pipe under a good or sufficient tightening force. Thereby solved is a problem that sealing property is lowered and fuel permeation resistance is impaired due to lack of tightening force during connection of the hose with the mating pipe. Further, the hose can be easily fitted on the mating pipe with a small force.

And, since the permanent elongation of the inner rubber layer is set equal to or less than 90%, it is prevented over a long period of time that the tightening force is decreased due to fatigue of the inner rubber layer and thereby a sealing pressure is lowered and the fuel permeation resistance is impaired.

The rubber hardness degree of the inner rubber layer 16 (in the hose 10 of FIG. 6, the first layer 16-1 and the second layer 16-2) may be set in a range of 65 to 80. Typically, in a fuel hose of multilayer laminated construction comprising a resin layer with fuel permeation resistance as a barrier layer, an inner rubber layer as an inner surface layer on an inner side of the resin layer and an outer rubber layer on an outer side of the resin layer, the rubber hardness degree of the outer rubber layer may be set equal to or greater than that of the inner rubber layer, a permanent elongation or permanent elongation rate of the inner rubber layer may be set equal to or less than 90%, and the rubber hardness degree of the inner rubber layer may be set in a range of 65 to 80. When the rubber hardness degree of the inner rubber layer exceeds 80, the inner rubber layer is too hard to favorably transmit the clamping force by the hose clamp to the inner rubber layer and to be deformed so as to follow a shape of the mating pipe, whereby the sealing property becomes insufficient, and a considerable force is required for fitting of the hose to the mating pipe resulting in less easiness of fitting of the hose. On the other hand, when the rubber hardness degree of the inner rubber layer is lower than 65, the tightening force at a connecting portion with a mating member (the mating pipe) is insufficient, and a pullout resistance with respect to the mating member (the mating pipe) in case of vehicle collision is impaired.

And, the rubber hardness degree of the outer rubber layer 14 (in the hose 10 of FIG. 7, the middle rubber layer 13 and the outer rubber layer 14) may be set in the range of 65 to 85. Typically, in a fuel hose of multilayer laminated construction comprising a resin layer with fuel permeation resistance as a barrier layer, an inner rubber layer as an inner surface layer on an inner side of the resin layer and an outer rubber layer on an outer side of the resin layer, the rubber hardness degree of the outer rubber layer may be set equal to or greater than that of the inner rubber layer, a permanent elongation or permanent elongation rate of the inner rubber layer may be set equal to or less than 90%, and the rubber hardness degree of the outer rubber layer may be set in a range of 65 to 85. When the rubber hardness degree of the outer rubber layer exceeds 85, the outer rubber layer is hard and breakable, and properties or physical properties such as an ozone resistance, a tear resistance strength, and a low-temperature resistance are impaired. Therefore, the rubber hardness degree of the outer rubber layer is set preferably up to 85. On the other hand, when the rubber hardness degree of the outer rubber layer is lower than 65, the outer rubber layer is more flexible than necessary. When an outer peripheral surface of the outer rubber layer is tightened by the hose clamp, the clamping force is absorbed only by the outer rubber layer and the tightening force is hard to be transmitted to the inner rubber layer through the middle resin layer. Here, the rubber hardness degree means a rubber hardness degree that measured by a durometer type A (spring scale) according to JISK6253.

Although the preferred embodiments have been described above, these are only some of embodiments of the present invention.

For example, in a hose having a plurality of curved portions, it is not necessary that all of the curved portions progressively and continuously increase in diameter. Namely, when the curved portion has a gentle curvature and does not exhibit a wave-shaped deformation behavior on an inner side thereof, the curved portion may be formed with a uniform diameter from its curve beginning end toward its curve terminal end through an entire length thereof.

In a hose having a single curved portion, progressive and continuous increase rate in diameter of the single curved portion can be determined to correspond to difference in diameter between the other axial end of the hose with small diameter and one axial end thereof with large diameter. Namely, a curve beginning end of the single curved portion may be equal to the other axial end of the hose in diameter, and a curve terminal end of the single curved portion may be equal to the one axial end of the hose in diameter.

The present invention can be embodied by a variety of modifications without departing from the scope of the invention.

What is claimed is:

1. A resin composite hose of curved shape including at least one curved portion at a certain axial position thereof and having a multilayer construction, the resin composite hose, comprising: a resin layer having permeation resistance to a transported fluid and serving as a barrier layer, an inner rubber layer as an inner surface layer on an inner side of the resin layer and an outer rubber layer on an outer side of the resin layer,
wherein:
the resin composite hose has one axial end that is larger in diameter than the other axial end of the resin composite hose, the curved portion is formed in a shape of continuously increasing diameter from a curve beginning end with a small diameter near the other axial end of the resin composite hose to a curve terminal end with a large diameter near the one axial end thereof.

2. The resin composite hose of curved shape as set forth in claim 1, wherein:
a plurality of the curved portions are formed at certain axial positions, each of the curved portions is formed in a shape of continuously increasing diameter from the curve beginning end to the curve terminal end, the plurality of the curved portions are arranged in order of increasing diameter from the other axial end of the resin composite hose toward the one axial end thereof.

3. Method for producing the resin composite hose of curved shape defined in claim 1, comprising:
a step of forming a straight tubular hose body by successively laminating the inner rubber layer, the resin layer and the outer rubber layer on one another by extrusion, the straight tubular hose body being multi-layered and plastically deformable, the straight tubular hose body being unvulcanized or semivulcanized,
a step of preparing a mandrel having a shape corresponding to a shape of inner surface of the resin composite hose of curved shape,
a step of relatively fitting the straight tubular hose body on the mandrel and deforming the straight tubular hose body to obtain a curved tubular hose body, and
a step of vulcanizing the curved tubular hose body to obtain the resin composite hose of curved shape.
